(19) United States
(12) Patent Application Publication
(10) Pub. No.: US 2026/0339273 A1
(43) Pub. Date: Oct. 29, 2026

(54) SMART WEARABLE SHELL STRUCTURE, SMART WEARABLE DEVICE, AND CONTROL METHOD OF SMART WEARABLE DEVICE

(71) Applicant: Luxshare Precision Technology (Nanjing) Co., LTD, Nanjing City (CN)

(72) Inventors: Haiyan ZHANG, Nanjing City (CN); Yamei GUO, Nanjing City (CN)

(73) Assignee: Luxshare Precision Technology (Nanjing) Co., LTD, Nanjing City (CN)

(21) Appl. No.: 19/314,286

(22) Filed: Aug. 29, 2025

(30) Foreign Application Priority Data
Apr. 25, 2025 (CN) 202510533886.4

(51) Int. Cl. G04G 21/08; G06F 3/0362

(52) U.S. Cl. CPC G04G 21/08; G06F 3/0362

(57) ABSTRACT

A smart wearable shell structure includes a housing, a touch sensing member and a manipulation assembly. An outer wall of the housing is provided with a wristband connection portion and an accommodation portion, a projection of the accommodation portion in a first direction at least partially overlaps a projection of the wristband connection portion in the first direction, and the first direction is a thickness direction of the housing. The touch sensing member is disposed within the housing. The manipulation assembly is slidably mounted on the accommodation portion, at least part of the manipulation assembly is exposed from the housing, one end of the manipulation assembly extends into the housing, and the manipulation assembly has a first state in which the manipulation assembly is kept stationary relative to the housing and a second state in which the manipulation assembly triggers the touch sensing member.

### CROSS-REFERENCE TO RELATED APPLICATIONS

This application claims priority to Chinese Patent Application No. 202510533886.4 filed Apr. 25, 2025, the disclosure of which is incorporated herein by reference in its entirety.

### TECHNICAL FIELD

The present disclosure relates to the technical field of smart wearable devices, and in particular, to a smart wearable shell structure, a smart wearable device, and a control method of a smart wearable device.

### BACKGROUND

A smart watch is a type of watch that has information processing capabilities and satisfies basic functions and technical requirements of the watch, and serves as a common smart wearable device.

In the related art, the smart watch has a display screen, and the display screen is used to display information such as pointers, numbers, images, and texts. The display screen is typically a touch screen, and a user can interact with the smart watch by touching the display screen. However, the operation is inconvenient due to the small size of the display screen. For example, after sliding to a desired event by touch, the user needs to click the event on the display screen to select the event. However, events on the display screen are typically represented as narrow strip-shaped graphics, while the finger pad of the user is usually relatively large, which may lead to issues with inaccurate clicking positions. For this purpose, the smart watch is often equipped with a pressable crown, and the user can interact with the smart watch by pressing the crown to achieve the selection of the event. In the related art, the crown is typically disposed on the left or right side of the housing, that is, the crown is disposed at the 3 o'clock direction of the smart watch. When the smart watch is worn on the left arm, the operation of the user is relatively convenient. However, when the smart watch is worn on the right arm, operating the crown can easily cause motion interference between the fingers and the wrist or back of the hand, resulting in inconvenient crown operation and low flexibility.

Therefore, there is an urgent need for a smart watch that is easy to operate.

### SUMMARY

The present disclosure provides a smart wearable shell structure to address the technical problem of inconvenient manipulation in the related art.

The present disclosure further provides a smart wearable device to address the technical problems of inconvenient operation and inflexibility in the related art.

The present disclosure further provides a control method of a smart wearable device, which is relatively simple.

A smart wearable shell structure includes a housing, a touch sensing member and a manipulation assembly. The housing has an outer wall, the outer wall of the housing is provided with a wristband connection portion and an accommodation portion, a projection of the accommodation portion in a first direction at least partially overlaps a projection of the wristband connection portion in the first direction, and the first direction is a thickness direction of the housing. The touch sensing member is disposed within the housing. The manipulation assembly is slidably mounted on the accommodation portion, at least part of the manipulation assembly is exposed from the housing, one end of the manipulation assembly extends into the housing, and the manipulation assembly has a first state in which the manipulation assembly is kept stationary relative to the housing and a second state in which the manipulation assembly triggers the touch sensing member.

In an embodiment, the manipulation assembly includes a rotary shaft key and a bracket, the bracket is slidably mounted on the accommodation portion, the rotary shaft key is rotatably connected to the bracket, so that the manipulation assembly has a third state in which the manipulation assembly rotates relative to the housing, and at least part of the rotary shaft key is exposed from the accommodation portion.

In an embodiment, the bracket is slidably mounted on the accommodation portion in a second direction, an axial direction of the rotary shaft key is a third direction, and every two of the second direction, the third direction and the first direction are perpendicular to each other.

In an embodiment, the smart wearable shell structure further includes a rotary sensing component, where the rotary sensing component is disposed on the accommodation portion and is electrically connected to a control module, and the rotary sensing component is configured to sense a rotation of the rotary shaft key, so that the control module performs a corresponding control according to the rotation of the rotary shaft key.

In an embodiment, the rotary sensing component is a photoelectric sensor, and the rotary shaft key has a light-transmitting structure in a circumferential direction of the rotary shaft key, to enable the rotary sensing component to sense the rotation of the rotary shaft key.

In an embodiment, the rotary shaft key includes a shaft key main body and multiple convex tooth portions, the multiple convex tooth portions are disposed at intervals in a circumferential direction of the shaft key main body, and the light-transmitting structure is formed between adjacent convex tooth portions among the multiple convex tooth portions.

In an embodiment, the accommodation portion has a light-transmitting portion, and the rotary sensing component and the rotary shaft key are disposed on two sides of the light-transmitting portion.

In an embodiment, the manipulation assembly further includes an elastic member, the elastic member is disposed between a side wall of the accommodation portion and the bracket, and the elastic member is configured to drive the bracket to move in a direction facing away from the touch sensing member, to enable the manipulation assembly to be automatically reset from the second state to the first state.

In an embodiment, the bracket includes a first plate, two second plates and two rotary shafts, the two second plates are disposed on a same side of the first plate, an end of each second plate of the two second plates is connected to a respective one of two ends of the first plate, the two rotary shafts are coaxially disposed and are connected to the two second plates in one-to-one correspondence, an end of the first plate extends into the housing, end surfaces of two ends of the rotary shaft key are respectively provided with rotary holes, and the two rotary shafts are rotatably inserted into the rotary holes in one-to-one correspondence.

In an embodiment, two wristband connection portions disposed opposite to each other are provided, at least one accommodation portion is provided, and each accommodation portion of the at least one accommodation portion is provided with the manipulation assembly. Alternatively, one accommodation portion is provided, and a projection of the accommodation portion in the first direction at least partially overlaps a projection of one wristband connection portion of the two wristband connection portions in the first direction. Alternatively, two accommodation portions are provided, the two accommodation portions are in one-to-one correspondence with the two wristband connection portions, and a projection of one accommodation portion of the two accommodation portion in the first direction at least partially overlaps a projection of a wristband connection portion, corresponding to the one accommodation portion, among the two wristband connection portions in the first direction.

A smart wearable device includes a control module and the smart wearable shell structure described above, and the control module is disposed inside the smart wearable shell structure.

A control method based on the smart wearable device described above includes: when the manipulation assembly is in the first state, feeding back a first signal to the control module; when the manipulation assembly is in the second state, feeding back a second signal to the control module; or when the manipulation assembly is in the third state, feeding back a third signal to the control module.

In an embodiment, two manipulation assemblies are provided. The two manipulation assemblies are capable of being operated in a combination of one of the first state, the second state and the third state of one control assembly, and one of the first state, the second state and the third state of another control assembly to feed back different signals to the control module.

### BRIEF DESCRIPTION OF DRAWINGS

In order to more clearly explain technical solutions in embodiments of the present disclosure, the drawings used for describing the embodiments of the present disclosure will be briefly introduced below. Apparently, the drawings to be introduced are merely the drawings of part of the embodiments of the present disclosure. For those of ordinary skill in the art, other drawings may also be obtained without creative labor according to the contents of the embodiments of the present disclosure and these drawings.

FIG. 1 is a top view of a smart wearable shell structure according to an embodiment of the present disclosure;

FIG. 2 is an exploded view of a smart wearable shell structure according to an embodiment of the present disclosure;

FIG. 3 is a sectional view of a smart wearable shell structure according to an embodiment of the present disclosure;

FIG. 4 is a schematic structural view of a first portion of a smart wearable shell structure according to an embodiment of the present disclosure;

FIG. 5 is a schematic structural view of a rotary shaft key according to an embodiment of the present disclosure;

FIG. 6 is a schematic diagram of an assembly of a manipulation assembly, a touch sensing member and a rotary sensing component according to an embodiment of the present disclosure;

FIG. 7 is an exploded view of a manipulation assembly according to an embodiment of the present disclosure;

FIG. 8 is a schematic structural view of a bracket according to an embodiment of the present disclosure;

FIG. 9 is a schematic structural view of a second portion of a smart wearable shell structure according to an embodiment of the present disclosure;

FIG. 10 is a front view of a smart wearable shell structure according to an embodiment of the present disclosure;

FIG. 11 is a side view of a smart wearable shell structure according to an embodiment of the present disclosure;

FIG. 12 is a schematic view of a first manipulation of a smart wearable shell structure according to an embodiment of the present disclosure;

FIG. 13 is a schematic diagram of a second manipulation of a smart wearable shell structure according to an embodiment of the present disclosure;

FIG. 14 is a schematic diagram of a third manipulation of a smart wearable shell structure according to an embodiment of the present disclosure;

FIG. 15 is a schematic diagram of a fourth manipulation of a smart wearable shell structure according to an embodiment of the present disclosure;

FIG. 16 is a schematic diagram of a fifth manipulation of a smart wearable shell structure according to an embodiment of the present disclosure;

FIG. 17 is a schematic diagram of a sixth manipulation of a smart wearable shell structure according to an embodiment of the present disclosure; and

FIG. 18 is a schematic diagram of a seventh manipulation of a smart wearable shell structure according to an embodiment of the present disclosure.

### DETAILED DESCRIPTION

In order to make the technical problems solved, the technical solutions adopted, and the technical effects achieved by the present disclosure clearer, the technical solutions of the present disclosure are further described below by way of specific embodiments in conjunction with the accompanying drawings. It is to be understood that the specific embodiments described herein are merely illustrative of the present disclosure and are not to be construed as limiting the present disclosure. It is to be further noted that, for the convenience of description, only some, but not all, of the features related to the present disclosure are shown in the drawings.

It is to be understood that the phrase "one embodiment" or "an embodiment" mentioned throughout the specification means that particular features, structures or characteristics related to the embodiments are included in at least one embodiment of the present disclosure. Therefore, the appearance of the phrase "in one embodiment" or "in an embodiment" in various places throughout the specification does not necessarily refer to the same embodiment. In addition, the particular features, structures, or characteristics may be combined in one or more embodiments in any suitable manner.

It is to be noted that similar reference numerals and letters represent similar items in the following drawings. Therefore, once an item is defined in one drawing, there is no need to further define and explain this item in the subsequent drawings.

In the description of the present disclosure, unless otherwise expressly specified and limited, the term "connected to each other", "connected", or "fixed" is to be construed in a broad sense, for example, as fixedly connected, detachably connected, or integrated; mechanically connected or electrically connected; directly connected to each other, indirectly connected to each other via an intermediary, internal connection between two elements, or interaction between two elements. For those of ordinary skill in the art, specific meanings of the preceding terms in the present disclosure can be understood based on specific situations.

In the present disclosure, unless otherwise expressly specified and limited, a first feature being "on" or "under" a second feature may include the first feature and the second feature being in direct contact, or may include the first feature and the second feature not being in direct contact but being in contact with each other through an additional feature therebetween. Moreover, the first feature being "on", "above" or "over" the second feature includes the first feature being directly on, above or over and obliquely on, above or over the second feature, or simply represents that the first feature is at a higher level than the second feature. The first feature being "under", "below" or "underneath" the second feature includes the first feature being directly under, below or underneath and obliquely under, below or underneath the second feature, or simply represents that the first feature is at a lower level than the second feature. In the description of this embodiment, unless otherwise specified, "multiple" specifically refers to two or more.

In the description of this embodiment, the orientational or positional relationships indicated by the terms such as "center", "longitudinal", "transverse", "length", "width", "thickness", "upper", "lower", "front", "rear", "left", "right", "vertical", "horizontal", "top", "bottom", "inside", "outside", "clockwise", "counterclockwise", "axial direction", "radial direction", and "circumferential direction" are based on the orientational or positional relationships shown in the drawings. These terms are merely for the convenience of description and simplification of operation, rather than indicating or implying that the referred device or element must have a specific orientation and must be constructed and operated in a specific orientation; therefore, they should not be construed as limiting the present disclosure. In addition, the terms "first" and "second" are merely used for distinguishing between descriptions and have no special meanings.

It is to be noted that when an element is referred to as being "fixed to" or "disposed on" another element, the element may be directly on another element, or there may be an intermediate element in between.

The technical solutions of the present disclosure will be further described below in conjunction with the drawings and through specific embodiments.

In a first aspect, this embodiment provides a smart wearable shell structure, which has relatively high flexibility and is easy to operate.

The smart wearable shell structure provided in this embodiment can be applied to a smart wearable device, and the smart wearable device includes, but is not limited to, a wrist-worn device such as a smart watch and a smart bracelet. Alternatively, the smart wearable device may also be an arm-worn device or other wearable devices.

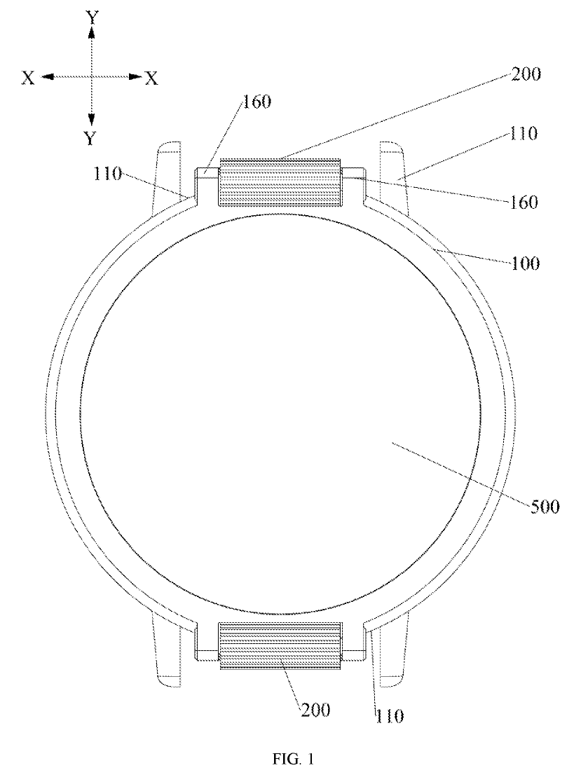

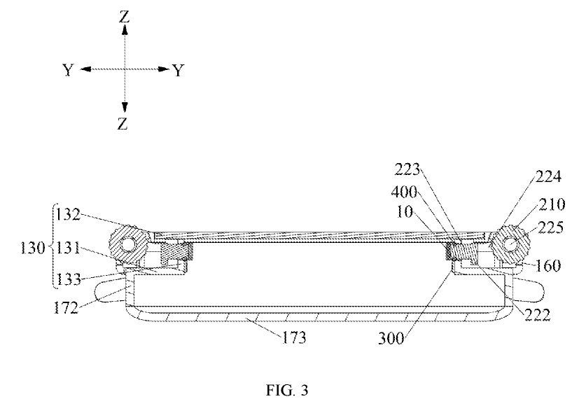

Exemplarily, as shown in FIGS. 1-11, the smart wearable shell structure includes a housing 100, a touch sensing member 10 and a manipulation assembly 200. As shown in FIGS. 1 and 3, an outer wall of the housing 100 is provided with a wristband connection portion 110 and an accommodation portion 130, and a projection of the accommodation portion 130 in a first direction Z at least partially overlaps a projection of the wristband connection portion 110 in the first direction Z. In this embodiment, the first direction Z is a thickness direction of the housing 100.

It is to be noted that the wristband connection portion 110 is configured to connect a wristband of the smart wearable device, so that the smart wearable device may be worn on a wrist or an arm of a user. It is also to be noted that when the smart wearable shell structure faces the face of the user, the top and bottom of the housing 100 are both provided with the wristband connection portion 110, that is, the housing 100 in this embodiment at least includes two wristband connection portions 110. At least part of the housing 100 forms the wristband connection portion. Optionally, the outer wall of the housing 100 is provided with an outer ear plate 111, and the wristband can be connected to the housing 100 by being connected to the outer ear plate 111. One end of the wristband is usually connected to two outer ear plates 111. The housing 100 is located between the two outer ear plates 111 connected to the one end of the wristband, and a portion extending to both sides of the housing 100 in the thickness direction of the housing 100 forms the wristband connection portion 110. Exemplarily, a portion enclosed by the dotted frame in FIG. 10 is one wristband connection portion 110 in this embodiment.

In this embodiment, the accommodation portion 130 may be disposed in the wristband connection portion 110, or outside the wristband connection portion 110, or partially in the wristband connection portion 110 and partially outside the wristband connection portion 110. However, it is necessary to ensure that the projection of the accommodation portion 130 in the first direction Z at least partially overlaps the projection of the wristband connection portion 110 in the first direction Z. Optionally, the accommodation portion 130 may be a part of the housing 100 or may be a structure independent of the housing 100, which is not limited in this embodiment.

Optionally, the housing 100 in this embodiment can be made of a metal material or a non-metal material, which is not limited in this embodiment.

Exemplarily, as shown in FIG. 3, the touch sensing member 10 is disposed within the housing 100, the manipulation assembly 200 is slidably mounted on the accommodation portion 130, and at least part of the manipulation assembly 200 is exposed from the housing 100, so that the user may contact the manipulation assembly 200, thereby implementing the manipulation of the manipulation assembly 200. Exemplarily, the user may drive the manipulation assembly 200 to slide relative to the housing 100, and one end of the manipulation assembly 200 extends into the housing 100. The manipulation assembly 200 has a first state in which the manipulation assembly 200 is kept stationary relative to the housing 100 and a second state in which the manipulation assembly 200 triggers the touch sensing member 10. When the manipulation assembly 200 triggers the touch sensing member 10 in the housing 100, the touch sensing member 10 is electrically connected to the control module of the smart wearable device, so that the control module implements a corresponding control according to the touch information of the touch sensing member 10, thereby implementing the interaction between the smart wearable device and the user. It is to be noted that the control module may be a controller in the related art, and the touch sensing member 10 may be a touch sensor in the related art, which is not limited in this embodiment. It is to be noted that the triggering of the touch sensing member 10 by the manipulation assembly 200 may be a contact triggering or a non-contact triggering, which is not limited in this embodiment.

The projection of the accommodation portion 130 in the first direction Z at least partially overlaps the projection of the wristband connection portion 110 in the first direction Z, so that the accommodation portion 130 is disposed close to the wristband connection portion 110. Moreover, the manipulation assembly 200 is mounted on the accommodation portion 130, therefore, the manipulation assembly 200 is disposed close to the wristband connection portion 110. The wristband connection portion 110 is located on the top and bottom of the housing 100; therefore, the manipulation assembly 200 in this embodiment is disposed at the top and/or bottom of the housing 100 or disposed to be closer to the top and/or bottom of the housing 100 rather than on the left side or the right side of the housing 100. The manipulation assembly 200 is disposed in a 12 o’clock direction and/or a 6 o’clock direction of the housing 100, so that no matter whether the smart wearable device is worn on the left arm or the right arm, when the other hand manually operates the manipulation assembly 200, the fingers and the wrist or back of the other hand will not produce motion interference, which is convenient for the operation of the manipulation assembly 200, and will not affect the normal operation of the manipulation assembly 200 due to the usage habits of the left and right hands. This design is more ergonomic and also makes the smart wearable shell structure and the smart wearable device more flexible.

It is to be noted that the projection of the accommodation portion 130 in the first direction Z at least partially overlapping the projection of the wristband connection portion 110 in the first direction Z can be understood as that the projection of the accommodation portion 130 in the first direction Z intersects with the projection of the wristband connection portion 110 in the first direction Z. That is, part of the projection of the accommodation portion 130 can coincide with the projection of the wristband connection portion 110, or all of the projection of the accommodation portion 130 can coincide with the projection of the wristband connection portion 110, which is not limited in this embodiment. Exemplarily, the wristband connection portion 110 may be part of an outer side wall of the housing 100. In this case, the projection of the wristband connection portion 110 in the first direction Z is one line, and the projection of the accommodation portion 130 in the first direction Z is one plane. In this embodiment, the intersection of the projection line and the projection plane is also considered to be coincident.

In some optional embodiments, one end of the manipulation assembly 200 can extend into the housing 100. In order to improve the waterproof performance of the smart wearable shell structure, the smart wearable shell structure further includes a sealing member, and the sealing member is disposed on the manipulation assembly 200 and/or the housing 100 and is configured to seal a gap between the manipulation assembly 200 and the housing 100, to reduce the risk of poor sealing inside the housing 100 caused by the manipulation assembly 200 passing through the housing 100. The sealing member includes, but is not limited to, a sealing colloid.

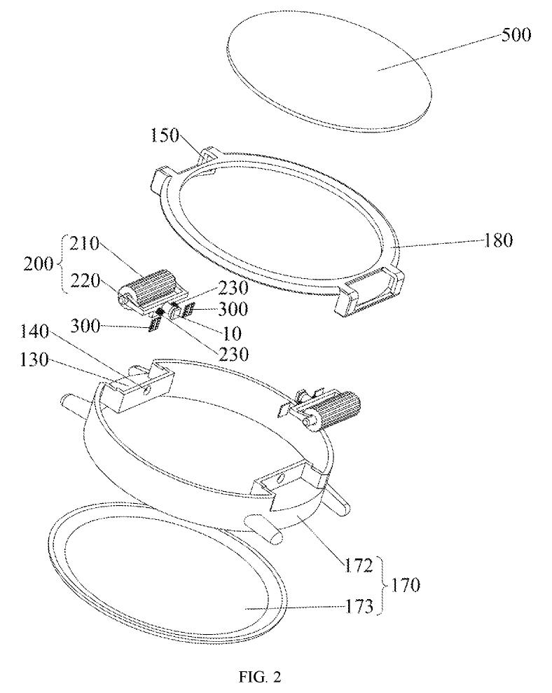

In an embodiment, exemplarily, as shown in FIG. 2, this embodiment provides a manipulation assembly 200, and the manipulation assembly 200 includes a rotary shaft key 210 and a bracket 220. The bracket 220 is slidably mounted on the accommodation portion 130, and one end of the bracket 220 extends into the housing 100, so that the manipulation assembly 200 has the second state and the first state. In this embodiment, the bracket 220 can trigger the touch sensing member 10 or remain stationary relative to the housing 100. The rotary shaft key 210 is rotatably connected to the bracket 220, so that the manipulation assembly 200 has a third state in which the manipulation assembly 200 rotates relative to the housing 100, that is, the rotary shaft key 210 can rotate relative to the bracket 220 and the housing 100. In some optional embodiments, the rotation of the rotary shaft key 210 is self-rotation, so that the movement space required by the rotary shaft key 210 can be relatively small, which is conducive to the miniaturization of the manipulation assembly 200. Furthermore, at least part of the rotary shaft key 210 is exposed from the accommodation portion 130, and the user can indirectly drive the bracket 220 to slide relative to the housing 100 by driving the rotary shaft key 210, thereby enabling the bracket 220 to trigger the touch sensing member 10. Exemplarily, the accommodation portion 130 is provided with a groove opening, and the rotary shaft key 210 is exposed from the accommodation portion 130 through the groove opening.

In some optional embodiments, the bracket 220 is slidably mounted on the accommodation portion 130 in a second direction Y, that is, a sliding direction of the bracket 220 is the second direction Y. An axial direction of the rotary shaft key 210 is a third direction X, where every two of the second direction Y, the third direction X and the first direction Z are perpendicular to each other. The sliding direction of the bracket 220 is disposed to be perpendicular to the axial direction of the rotary shaft key 210, and the rotary shaft key 210 does not extend in the thickness direction of the housing 100, so that the length of the rotary shaft key 210 is not limited by the thickness of the housing 100, and the thickness of the housing 100 is not too large due to the excessive length of the rotary shaft key 210. As a result, the overall size of the manipulation assembly 200 can be relatively small, which is conducive to the miniaturization and thinning of the manipulation assembly 200, and improves the space utilization rate of the smart wearable shell structure.

Optionally, the smart wearable shell structure further includes a display screen 500 disposed on a side of the housing 100 in the first direction Z. The display screen 500 is configured to display information such as an image and text. In this embodiment, a rotation axis of the rotary shaft key 210 is parallel to the display screen 500, and when the housing 100 has a square structure, the rotation axis of the rotary shaft key 210 is parallel to a circumferential side wall of the housing 100. When the housing 100 has a circular structure, the rotation axis of the rotary shaft key 210 is parallel to a tangent plane of the circumferential side wall of the housing 100. Such an arrangement enables the rotation of the rotary shaft key 210 to be more convenient for operation, so that interference when the left hand and the right hand are exchanged to operate can be avoided.

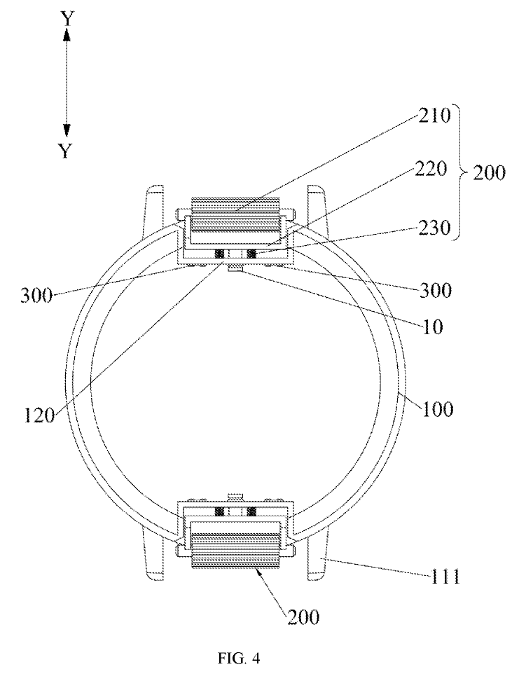

In some optional embodiments, the rotation of the rotary shaft key 210 in this embodiment can also be used as the input of a control signal. Specifically, as shown in FIGS. 2 and 4, the smart wearable shell structure further includes a rotary sensing component 300. The rotary sensing component 300 is disposed on the accommodation portion 130 and is electrically connected to the control module. The rotary sensing component 300 is configured to sense the rotation of the rotary shaft key 210, so that the control module implements corresponding control according to the rotation of the rotary shaft key 210. With such an arrangement, when the rotary shaft key 210 rotates under the action of an external force, the rotary sensing component 300 can generate sensing information and send the sensing information to the control module, so that the control module implements corresponding control according to the sensing information, thereby enriching functions of the manipulation assembly 200 and enabling the manipulation assembly 200 to have multiple control modes.

The rotary sensing component 300 may have multiple manners to sense the rotation of the rotary shaft key 210.

In an embodiment, the rotary sensing component 300 is a photoelectric sensor. As shown in FIG. 4, the accommodation portion 130 has a light-transmitting portion 120, and the rotary sensing component 300 and the rotary shaft key 210 are disposed on two sides of the light-transmitting portion 120. Light can pass through the light-transmitting portion 120 and be sensed by the photoelectric sensor. The structure of the rotary shaft key 210 varies in the circumferential direction so that the rotary sensing component 300 can sense the rotation of the rotary shaft key 210 that rotates. It is to be noted that the light enters the accommodation portion 130 through a gap between the rotary shaft key 210 and the housing 100, passes through the light-transmitting portion 120, and then irradiates onto the photoelectric sensor. The structure of the rotary shaft key 210 varies in the circumferential direction, so that when the rotary shaft key 210 rotates, the amounts of light irradiated onto the photoelectric sensor will be different, the photoelectric sensor generates sensing information according to the difference in the amount of received light, and the control module performs corresponding control according to the acquired sensing information.

In other embodiments, the rotary sensing component 300 may also be a displacement sensor. The displacement sensor is configured to monitor the distance between the displacement sensor and the rotary shaft key 210, the structure of the rotary shaft key 210 varies in the circumferential direction, so that when the rotary shaft key 210 rotates, the distance between the rotary shaft key 210 and the displacement sensor changes, the displacement sensor generates sensing information based on the change in distance, and the control module performs corresponding control based on the acquired sensing information.

In some optional embodiments, when the rotary sensing component 300 is a photoelectric sensor, the rotary shaft key 210 has a light-transmitting structure in the circumferential direction of the rotary shaft key 210 to enable the rotary sensing component 300 to sense the rotation of the rotary shaft key 210. The light-transmitting structure is provided so that when the rotary shaft key 210 rotates, the amounts of light irradiated onto the photoelectric sensor will be different, the photoelectric sensor generates sensing information according to the difference in the amount of received light, and the control module performs corresponding control according to the acquired sensing information.

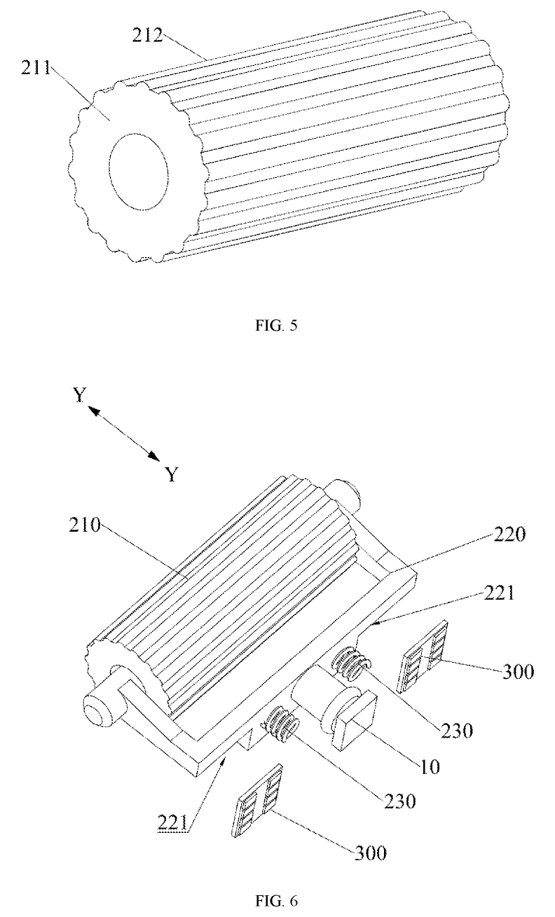

Further optionally, as shown in FIG. 5, the rotary shaft key 210 includes a shaft key main body 211 and multiple convex tooth portions 212. The multiple convex tooth portions 212 are disposed at intervals in a circumferential direction of the shaft key main body 211, and a light-transmitting structure is formed between adjacent convex tooth portions 212, that is, the light-transmitting structure in this embodiment is specifically a groove. With such an arrangement, when the rotary sensing component 300 is a photoelectric sensor, the amount of light entering the interior of the accommodation portion 130 from the space between the light-transmitting structure and the housing 100 can be greater than the amount of light entering the interior of the accommodation portion 130 from the space between the convex tooth portions 212 and the housing 100, thereby enabling the photoelectric sensor to sense the rotation of the rotary shaft key 210.

Of course, it is to be understood that the rotary shaft key 210 may have no convex tooth portion 212. Instead, a depression may be formed on the surface of the shaft key main body 211, so that the rotation of the rotary shaft key 210 can also be sensed by the photoelectric sensor, which is not limited in this embodiment.

The light-transmitting portion 120 located between the rotary sensing component 300 and the rotary shaft key 210 is provided. The light passing through the light-transmitting structure can penetrate the light-transmitting portion 120 and then be sensed by the photoelectric sensor, so that the housing 100 does not block the light.

The bracket 220 is also located between the rotary sensing component 300 and the rotary shaft key 210. In order to avoid the problem of the bracket 220 blocking the light, as shown in FIG. 6, the bracket 220 is provided with an avoidance notch 221. In the arrangement direction of the rotary shaft key 210, the light-transmitting portion 120 and the photoelectric sensor, a projection of the avoidance notch 221 at least partially overlaps a projection of the rotary sensing component 300. With such an arrangement, it is ensured that the light outside the housing 100 passes through the gap between the rotary shaft key 210 and the housing 100, the avoidance notch 221, and the light-transmitting portion 120, and then irradiates the photoelectric sensor, thereby improving the reliability and accuracy of sensing of the photoelectric sensor.

To further enhance the accuracy of the rotary sensing component 300 in sensing the rotation of the rotary shaft key 210, as shown in FIG. 6, for one manipulation assembly 200, multiple rotary sensing components 300 may be provided. Correspondingly, multiple avoidance notches 221 may be provided, the multiple rotary sensing components 300 are in one-to-one correspondence with the multiple avoidance notches 221. In the arrangement direction of the rotary shaft key 210, the light-transmitting portion 120 and the photoelectric sensor, a projection of each avoidance notch of the multiple avoidance notches 221 at least partially overlaps a projection of the rotary sensing component 300 corresponding to the avoidance notch. In this embodiment, two rotary sensing components 300 and two avoidance notches 221 are provided.

Optionally, when the rotary sensing component 300 is the photoelectric sensor, the rotary shaft key 210 and the rotary sensing component 300 are located on two sides in a thickness direction of the light-transmitting portion 120. In this way, the light only needs to pass through the light-transmitting portion 120 in the thickness direction of the light-transmitting portion 120, thus shortening the light's path through the light-transmitting portion 120, thereby reducing the light loss, and making the detection accuracy of the photoelectric sensor higher.

In some optional embodiments, the rotation axis of the rotary shaft key 210 is parallel to the light-transmitting portion 120. With such an arrangement, when multiple photoelectric sensors are provided, the multiple photoelectric sensors may be arranged at intervals in the axial direction of the rotary shaft key 210, reducing the mounting difficulty of the photoelectric sensor. The light-transmitting structures, varying in the circumferential direction, of the rotary shaft key 210 can be configured in a simpler manner. For example, the light-transmitting structures on the rotary shaft key 210 are uniform in the axial direction, so that the light intensity sensed by each photoelectric sensor at the same moment is consistent. This design facilitates the analysis of the sensing information of the photoelectric sensor by the control module, reduces the difficulty of calculation and control, enables the rapid response of the smart wearable device, and reduces the energy consumption of the smart wearable device.

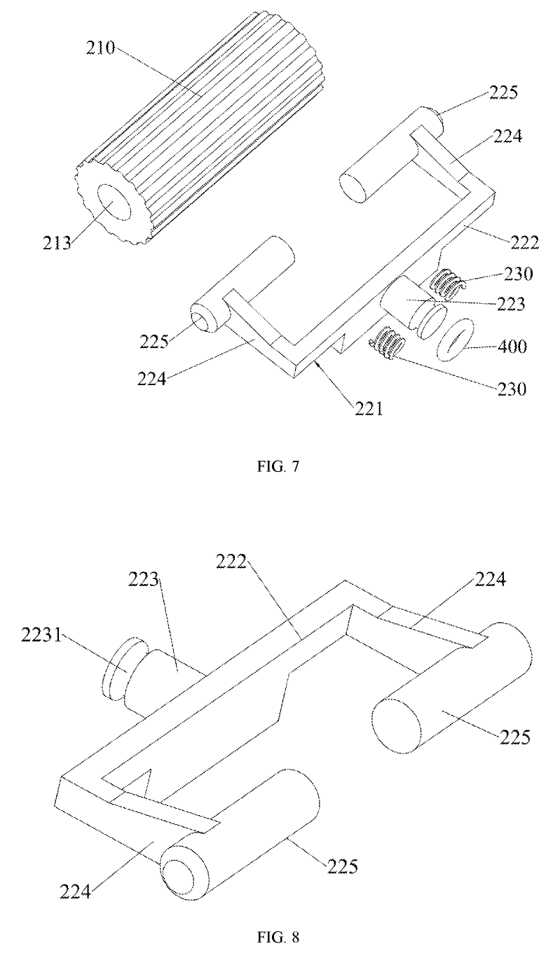

In some optional embodiments, this embodiment provides a bracket 220, as shown in FIGS. 7 or 8, the bracket 220 includes a first plate 222, two second plates 224 and two rotary shafts 225. The movement of the first plate 222 can trigger the touch sensing member 10. The two second plates 224 are disposed on the same side of the first plate 222, and the two second plates 224 are correspondingly connected to two ends of the first plate 222. The two rotary shafts 225 are coaxially disposed and are correspondingly connected to the two second plates 224, and an end of the first plate 222 facing away from the second plate 224 extends into the housing 100 to trigger the touch sensing member 10. As shown in FIG. 5, each of end surfaces of two ends of the rotary shaft key 210 is provided with a rotary hole 213, and the two rotary shafts 225 are in one-to-one correspondence with the two rotary holes 213. The rotary shaft 225 is rotatably inserted into the corresponding rotary hole 213, so that the rotary shaft key 210 can rotate around the rotary shaft 225.

In an embodiment, as shown in FIG. 7, a side of the first plate 222 facing away from the second plate 224 may have a trigger post 223, and the trigger post 223 is configured to trigger the touch sensing member 10. Exemplarily, the trigger post 223 may be in contact with the touch sensing member 10 to trigger the touch sensing member 10.

It is to be noted that the above-described avoidance notch 221 is disposed on the first plate 222. It is also noted that at least part of the first plate 222 forms the above-described light-transmitting portion 120.

The bracket 220 provided in this embodiment has a simpler structure and requires less space to be occupied, which facilitates the miniaturization and lightweight of the manipulation assembly 200. The rotary shaft key 210 and the trigger post 223 are disposed on two sides of the first plate 222, respectively, thereby fully utilizing the space on the two sides of the first plate 222. It is to be understood that the structure of the bracket 220 is not limited to the above-described structure and may be adjusted according to practical requirements.

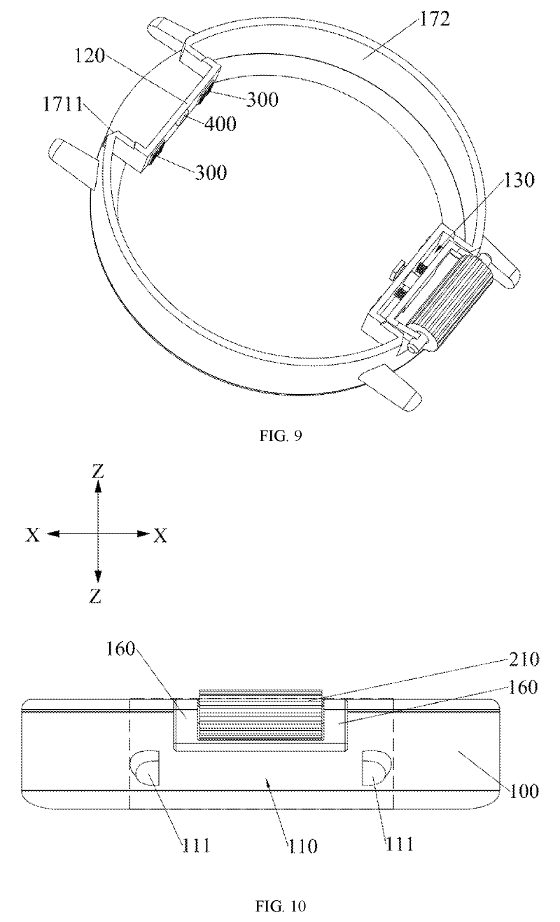

Exemplarily, as shown in FIGS. 2 and 9, a side wall of the accommodation portion 130 is provided with a through hole 140 communicating with the interior of the housing 100. Specifically, a side wall of the accommodation portion 130 close to the center of the housing 100 is provided with the through hole 140. The bracket 220 may be sheltered in the accommodation portion 130, thereby protecting the bracket 220 and reducing the impact of the dust and the like on the bracket 220. Moreover, one end of the bracket 220 passes through the through hole 140 and extends into the housing 100 (specifically, referring to the portion of the housing 100 excluding the accommodation portion 130). When the bracket 220 includes the trigger post 223, the trigger post 223 passes through the through hole 140 and extends into the housing 100, so as to be able to contact the touch sensing member 10. The rotary shaft key 210 is disposed in the groove opening of the accommodation portion 130, so as to be able to expose the accommodation portion 130 from the groove opening of the accommodation portion 130.

In other optional embodiments, the side wall of the accommodation portion 130 may also not be provided with the through hole 140. In this case, the bracket 220 can trigger the touch sensing member 10 by means of distance change.

In order to realize the restriction of the sliding range of the bracket 220, optionally, as shown in FIG. 2, the stop portion 150 is disposed at the groove opening of the accommodation portion 130, and the stop portion 150 cooperates with the side wall of the accommodation portion 130 to restrict the sliding range of the bracket 220. With such an arrangement, the bracket 220 will not come out of the accommodation portion 130 during sliding, thereby ensuring the rationality of the overall smart wearable shell structure. Exemplarily, as shown in FIG. 2, two stop portions 150 are oppositely disposed at the groove opening of the accommodation portion 130, to improve the effect of stopping the bracket 220. The rotary shaft key 210 is located between the two stop portions 150, so that the limiting of the rotary shaft key 210 in the axial direction can be achieved by the stop portions 150 to prevent the rotary shaft key 210 from swaying left and right.

In order to provide a relatively large movement space and mounting space for the manipulation assembly 200, exemplarily, as shown in FIG. 1, part of the housing 100 extends outwardly and forms two protrusion portions 160, the two protrusion portions 160 form part of the side wall of the accommodation portion 130, and the rotary shaft key 210 is located between the two protrusion portions 160, so that the axial limitation can be achieved through the two protrusion portions 160 to prevent significant swaying of the rotary shaft key 210 in the axial direction. With such an arrangement, part of the bracket 220 may be located in the protrusion portion 160, thereby reducing the space occupied by the bracket 220 inside the housing 100. It is to be noted that a gap is formed between the protrusion portion 160 and the end surface of the rotary shaft key 210 to enable the rotary shaft key 210 to move in the second direction Y relative to the protrusion portion 160, thereby preventing the rotary shaft key 210 from jamming between the two protrusion portions 160. Optionally, at least part of the protrusion portion 160 forms the stop portion 150 described above.

In order to improve the sealing performance and the waterproof performance of the smart wearable shell structure, in this embodiment, the accommodation portion 130 communicates with the interior of the housing 100 only through the through hole 140. The trigger post 223 of the bracket 220 is disposed to pass through the through hole 140. As shown in FIGS. 6 and 7, a sealing ring 400 is disposed between the trigger post 223 and the hole wall of the through hole 140 to seal a gap between the trigger post 223 and the hole wall of the through hole 140. With such an arrangement, the through hole 140 serves as the only channel for communication between the interior of the housing 100 and the outside. A gap between the hole wall of the through hole 140 and the trigger post 223 of the bracket 220 is sealed, the interior of the housing 100 may be in a sealed state, whereby the smart wearable shell structure may have the relatively high waterproof performance and satisfy the sealing requirements.

In an embodiment, as shown in FIGS. 6 and 7, the sealing ring 400 may be fixedly sleeved on the trigger post 223, and the outer wall surface of the sealing ring 400 may always be in sealed contact with the hole wall of the through hole 140. For example, a sealing groove 2231 may be disposed on the trigger post 223, and the sealing ring 400 is clamped in the sealing groove 2231.

In other embodiments, the sealing ring 400 may also be fixedly disposed on the housing 100 and is coaxially disposed with the through hole 140., and the inner wall of the sealing ring 400 may always be in sealed contact with the trigger post 223, thereby enabling the sealing between the trigger post 223 and the hole wall of the through hole 140.

The manipulation assembly 200 provided in this embodiment has a function of automatic reset. Specifically, as shown in FIGS. 4, 6, or 7, the manipulation assembly 200 further includes an elastic member 230. The elastic member 230 is disposed between a side wall of the accommodation portion 130 and the bracket 220, and the elastic member 230 is configured to drive the bracket 220 to move in a direction facing away from the touch sensing member 10, to enable the manipulation assembly 200 to be automatically reset from the second state to the first state. With such an arrangement, a direction of the elastic force of the elastic member 230 is opposite to a direction of driving the bracket 220 to trigger the touch sensing member 10, so that only one external force needs to be manually applied to the bracket 220 during operation, thereby making the manipulation assembly 200 smarter, more automated, and easier to operate and use. Exemplarily, the elastic member 230 may be a spring, an elastic strip, an elastic block, and the like, which is not limited in this embodiment.

In an embodiment, one end of the elastic member 230 abuts against the first plate 222, the other end of the elastic member 230 abuts against the bracket 220, and the elastic member 230 extends in the second direction Y.

Exemplarily, as shown in FIG. 3, the accommodation portion in this embodiment is formed by enclosing a bottom baffle plate 131, a top baffle plate 132, and multiple side baffle plates 133 disposed between the bottom baffle plate 131 and the top baffle plate 132. The multiple side baffle plates 133 include at least one transparent plate, and at least part of the at least one transparent plate forms the above-described light-transmitting portion 120. The through hole 140 is disposed on the transparent plate, and an end of the elastic member 230 facing away from the first plate 222 abuts against the transparent plate.

It is to be noted that the bottom baffle plate 131, the top baffle plate 132 and the side baffle plates 133 are part of the housing 100. The housing 100 in this embodiment may be a split structure or a one-piece structure, which is not limited in this embodiment.

In order to facilitate the assembly of the housing 100, the housing 100 is of a split structure. As shown in FIG. 2, the housing 100 includes a bottom shell 170 and an upper frame 180, the bottom shell 170 has an opening, and the upper frame 180 is sealingly connected to an open end of the bottom shell 170 and cooperates with the bottom shell 170 to form the accommodation cavity and the above-described accommodation portion 130. The accommodation cavity is configured to accommodate electronic components of the smart wearable device. For example, the touch sensing member 10, the rotary sensing component 300, and the control module, and the like in this embodiment are located within the accommodation cavity. The accommodation cavity communicates with the accommodation portion 130 through the through hole 140, and one end of the trigger post 223 of the bracket 220 passes through the through hole 140 and extends into the accommodation cavity. The accommodation portion 130 is located on a side of the accommodation cavity, and specifically, the accommodation portion 130 and the accommodation cavity are arranged in the second direction Y. In this embodiment, the display screen 500 is sealingly mounted on the upper frame 180. Exemplarily, the upper frame 180 in this embodiment is one frame to facilitate mounting of the display screen 500.

Exemplarily, as shown in FIG. 2, a surface of the bottom shell 170 towards the upper frame 180 is provided with a first groove 171. The first groove 171 extends to a circumferential side wall of the bottom shell 170. The circumferential side wall of the bottom shell 170 is provided with an avoidance bevel 1711 extending to the first groove 171. The avoidance bevel 1711 is configured to avoid the rotary shaft 225 of the bracket 220, so as to prevent the rotary shaft 225 from moving in the second direction Y to the bottom shell 170 and interfering with the bottom shell 170. The upper frame 180 covers part of the first groove 171 and forms the above-described accommodation portion 130. In some optional embodiments, the bottom shell 170 includes a bottom plate 173 and a center frame 172 sealingly connected to the bottom plate 173, the upper frame 180 is sealingly connected to the center frame 172, and the center frame 172 is provided with the above-described first groove 171.

In an embodiment, one accommodation portion 130 is provided, and the projection of the one accommodation portion 130 in the first direction Z at least partially overlaps the projection of one wristband connection portion 110 in the first direction Z. With such an arrangement, the manipulation assembly 200 is disposed at the top or bottom of the housing 100, which facilitates the manipulation of the manipulation assembly 200.

In some other embodiments, as shown in FIG. 1, two accommodation portions 130 are provided, and each of the two accommodation portions 130 is provided with the manipulation assembly 200. The two accommodation portions 130 are in one-to-one correspondence with the two wristband connection portions 110, and the projection of each accommodation portion 130 in the first direction Z at least partially overlaps the projection of the wristband connection portion 110 corresponding to the accommodation portion 130 in the first direction Z. The two manipulation assemblies 200 are provided, an external force may be selectively applied to one of the two manipulation assemblies 200, or an external force may be applied to the two manipulation assemblies 200 at the same time, thereby making the control manner more flexible and further improving the convenience of applying the external force to the manipulation assemblies 200. It is to be noted that each manipulation assembly 200 is correspondingly provided with the touch sensing member 10 and at least one rotary sensing component 300, which is not limited in this embodiment.

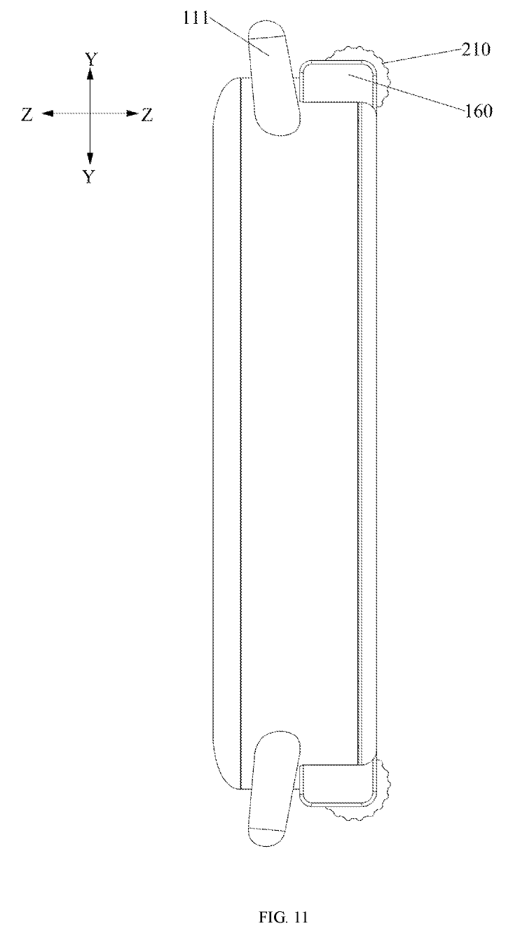

Optionally, as shown in FIG. 11, the two outer ear plates 111 connected to one end of the wristband are disposed opposite to each other in the third direction X. The accommodation portion 130 is located between the two outer ear plates 111 in the third direction X. That is, the manipulation assembly 200 is disposed between the two outer ear plates 111 in the third direction X. The third direction X is perpendicular to the first direction Z. With such an arrangement, the manipulation assembly 200 is disposed closer to the wristband. Since the wristband is located in the 12 o'clock direction and the 6 o'clock direction of the housing 100, the manipulation assembly 200 may also be located in the 12 o'clock direction and/or the 6 o'clock direction of the housing 100, so that the position of the manipulation assembly 200 is more convenient for operation, and the structure protruding from the housing 100 is more concentrated, which is conducive to the aesthetics of the smart wearable shell structure.

In some optional embodiments, when the smart wearable shell structure includes the display screen 500 disposed on the housing 100, the manipulation assembly 200 is closer to the display screen 500 than the outer ear plate 111 in the first direction Z, that is, the manipulation assembly 200 is disposed above the outer ear plate 111 in the first direction Z. With such an arrangement, the wristband does not block the manipulation assembly 200, thereby further facilitating finger operation by the user on the manipulation assembly 200 and improving the convenience and flexibility of manipulation.

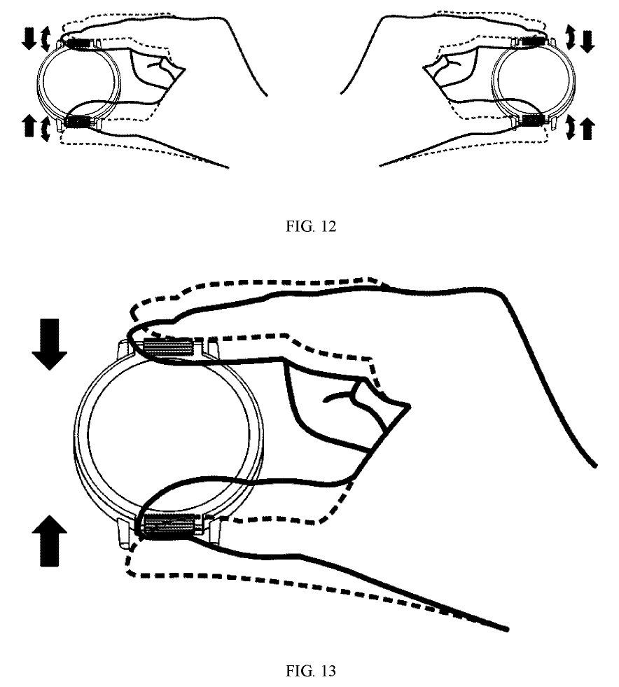

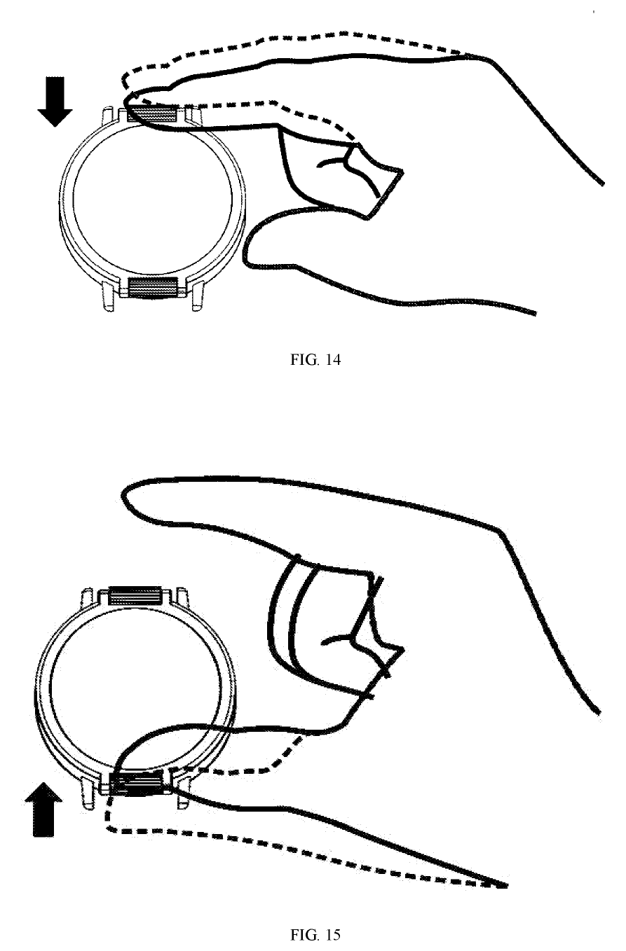

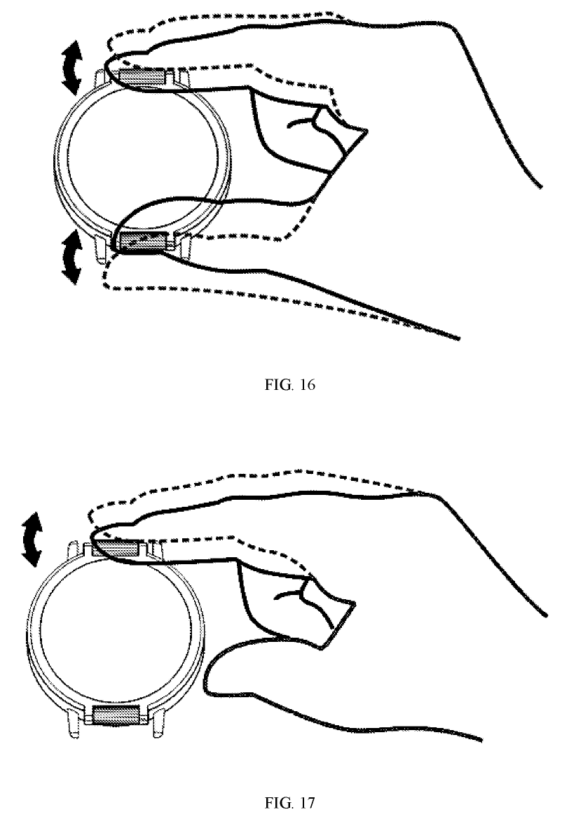

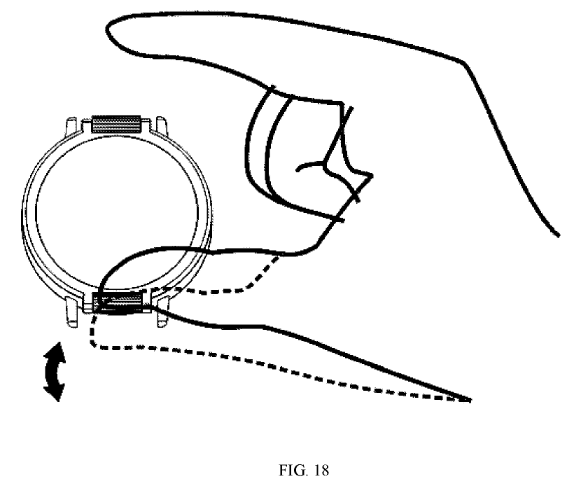

The smart wearable shell structure provided in this embodiment, when the smart wearable device is worn interchangeably by the left and right hands, regardless of whether the smart wearable device is rotated by 180 degrees, the normal operation of the manipulation assembly 200 will not be affected by the left-right hand usage habits. When two manipulation assemblies 200 are provided, the two manipulation assemblies 200 may be located in the 12 o'clock direction and the 6 o'clock direction of the housing 100, in this case, the left hand or the right hand and the wrist wearing the watch are in the same horizontal direction without rotating by 90 degrees, thereby making the design more ergonomic. As shown in FIGS. 12-18, the interaction with the smart wearable device is achieved by toggling the two manipulation assemblies 200 with the index finger and the thumb.

In a second aspect, this embodiment further provides a smart wearable device, including the aforementioned smart wearable shell structure described above. Moreover, the smart wearable device further includes a control module, and the control module is disposed inside the smart wearable shell structure. The manipulation assembly 200 may be in the second state under the driving of the external force, to further trigger the touch sensing member 10, and the control module may perform corresponding control according to the touch information of the touch sensing member 10.

According to the smart wearable device provided in this embodiment, the manipulation assembly 200 is disposed in the 12 o'clock direction and/or the 6 o'clock direction of the housing 100, so that no matter whether the smart wearable device is worn on the left arm or the right arm, when the other hand manually operates the manipulation assembly 200, the fingers and the wrist or back of the other hand will not produce motion interference, which is convenient for the operation of the manipulation assembly 200, and will not affect the normal operation of the manipulation assembly 200 due to the usage habits of the left and right hands. This design is more ergonomic and also makes the smart wearable shell structure and the smart wearable device more flexible.

Optionally, when the smart wearable shell structure further includes the rotary sensing component 300, the rotary sensing component 300 is connected to the control module, and the control module is configured to perform corresponding control according to the sensing information of the rotary sensing component 300. The rotary sensing component 300 is provided so that the smart wearable device is made more functional and more flexible.

In an embodiment, the smart wearable device further includes a vibration motor (not shown in the drawings) disposed within the housing 100, and the vibration motor is connected to the control module and is configured to implement a vibration feedback.

In a third aspect, this embodiment further provides a control method of a smart wearable device, and the control method of the smart wearable device is based on the smart wearable device provided in the second aspect.

In some optional embodiments, when the manipulation assembly 200 is in the first state, a first signal is fed back to the control module, where the first state in which the manipulation assembly 200 is located is a state in which the manipulation assembly 200 is relatively stationary relative to the housing 100.

Exemplarily, the control method of the smart wearable device includes that: when the manipulation assembly 200 is in the second state, a second signal is fed back to the control module, where the second state in which the manipulation assembly 200 is located is a state in which the manipulation assembly 200 is capable of triggering the touch sensing member 10.

It is to be noted that when the manipulation assembly 200 is in the second state and the first state, the manipulation assembly 200 may interact with the touch sensing member 10, and the touch sensing member 10 is communicatively connected to the control module, so that the control module may acquire sensing information of the touch sensing member 10 and may further generate the first signal or the second signal according to the sensing information, to implement the corresponding control.

In some optional embodiments, when the manipulation assembly 200 is in the third state, a third signal is fed back to the control module, where the third state in which the manipulation assembly 200 is located is a state in which the manipulation assembly 200 is rotatable relative to the housing 100 or the accommodation portion 130.

When the manipulation assembly 200 is in the third state, the manipulation assembly 200 may interact with the rotary sensing component 300, and the rotary sensing component 300 is communicatively connected to the control module, so that the control module may acquire rotation information of the rotary sensing component 300 and may further generate the third signal according to the rotation information, to implement the corresponding control.

According to the control method of the smart wearable device provided in this embodiment, the manipulation component in different states may feed back different signals to the control module, thereby enabling the control module to perform the corresponding control based on the feedback signals.

The control method of the smart wearable device provided in this embodiment is relatively simple, the user may control the manipulation component to be in the first state, the second state, or the third state according to the demands, to make the touch sensing member 10 and the rotary sensing component 300 feed back signals to the control module, thereby enabling the control of the smart wearable device. This allows the user to quickly control the smart wearable device and significantly enhances the comfort of user control over the smart wearable device.

In some optional embodiments, when two manipulation assemblies 200 are provided, the two manipulation assemblies 200 are capable of being operated in a combination of one of the first state, the second state and the third state of one control assembly, and one of the first state, the second state and the third state of another control assembly to feed back different signals to the control module. With such an arrangement, the smart wearable device may have a variety of control methods, thereby being able to achieve a variety of functions, more flexible control, and richer functions.

Exemplarily, the two manipulation assemblies 200 may be in the first state, the second state, or the third state. Alternatively, one of the two manipulation components 200 is in the first state, and the other of the two manipulation components 200 is in the second state or the third state, and a variety of combinations exist, which will not be listed one by one in this embodiment.

As shown in FIGS. 12-15, the transition of the manipulation assembly 200 between the first state and the second state may be achieved by pressing the rotary shaft key 210 of the manipulation assembly 200, and the manners of pressing the rotary shaft key 210 include, but are not limited to, a long press, a short press, and multiple consecutive presses, and the like, which is not be limited in this embodiment. In this case, the interface control corresponding to the smart wearable device may be selecting options on the interface.

As shown in FIGS. 16-18, the manipulation assembly 200 may be in the third state by controlling the rotation of the rotary shaft key 210. The rotation of the rotary shaft key 210 may be a clockwise rotation or a counterclockwise rotation, which is not limited in this embodiment. The rotation of the rotary shaft key 210 may control the interface scrolling or other functions on the display screen 500, which is not limited in this embodiment.

It is to be noted that, as shown in FIGS. 12-18, the user may control the states of the two manipulation assemblies 200 through the index finger and/or the thumb of the palm, thereby making the operation relatively convenient and labor-saving.

The smart wearable device provided in this embodiment may have multiple interaction modes. In each interaction mode, the user may conveniently operate the rotary shaft key, which has high flexibility, rich functions, and reduces the risk of inconvenient operation.

What is claimed is:

1. A smart wearable shell structure, comprising:
a housing, wherein an outer wall of the housing is provided with a wristband connection portion and an accommodation portion, a projection of the accommodation portion in a first direction at least partially overlaps a projection of the wristband connection portion in the first direction, and the first direction is a thickness direction of the housing;
a touch sensing member disposed within the housing; and
a manipulation assembly, slidably mounted on the accommodation portion, wherein at least part of the manipulation assembly is exposed from the housing, one end of the manipulation assembly extends into the housing, the manipulation assembly has a first state in which the manipulation assembly is kept stationary relative to the housing and a second state in which the manipulation assembly triggers the touch sensing member.

2. The smart wearable shell structure of claim 1, wherein the manipulation assembly comprises a rotary shaft key and a bracket, the bracket is slidably mounted on the accommodation portion, the rotary shaft key is rotatably connected to the bracket, so that the manipulation assembly has a third state in which the manipulation assembly rotates relative to the housing, and at least part of the rotary shaft key is exposed from the accommodation portion.

3. The smart wearable shell structure of claim 2, wherein the bracket is slidably mounted on the accommodation portion in a second direction, an axial direction of the rotary shaft key is a third direction, and every two of the second direction, the third direction and the first direction are perpendicular to each other.

4. The smart wearable shell structure of claim 2, further comprising a rotary sensing component, wherein the rotary sensing component is disposed on the accommodation portion and is electrically connected to a control module, and the rotary sensing component is configured to sense a rotation of the rotary shaft key, so that the control module performs a corresponding control according to the rotation of the rotary shaft key.

5. The smart wearable shell structure of claim 4, wherein the rotary sensing component is a photoelectric sensor, and the rotary shaft key has a light-transmitting structure in a circumferential direction of the rotary shaft key to enable the rotary sensing component to sense the rotation of the rotary shaft key.

6. The smart wearable shell structure of claim 5, wherein the rotary shaft key comprises a shaft key main body and a plurality of convex tooth portions, the plurality of convex tooth portions are disposed at intervals in a circumferential direction of the shaft key main body, and the light-transmitting structure is formed between adjacent convex tooth portions among the plurality of convex tooth portions.

7. The smart wearable shell structure of claim 5, wherein the accommodation portion has a light-transmitting portion, and the rotary sensing component and the rotary shaft key are disposed on two sides of the light-transmitting portion.

8. The smart wearable shell structure of claim 2, wherein the manipulation assembly further comprises an elastic member, the elastic member is disposed between a side wall of the accommodation portion and the bracket, and the elastic member is configured to drive the bracket to move in a direction facing away from the touch sensing member to enable the manipulation assembly to be automatically reset from the second state to the first state.

9. The smart wearable shell structure of claim 2, wherein the bracket comprises a first plate, two second plates and two rotary shafts, the two second plates are disposed on a same side of the first plate, an end of each second plate of the two second plates is connected to a respective one of two ends of the first plate, the two rotary shafts are coaxially disposed and are connected to the two second plates in one-to-one correspondence, an end of the first plate extends into the housing, end surfaces of two ends of the rotary shaft key are respectively provided with rotary holes, and the two rotary shafts are rotatably inserted into the rotary holes in one-to-one correspondence.

10. The smart wearable shell structure of claim 1, wherein two wristband connection portions opposite to each other are provided, at least one accommodation portion is provided, and each accommodation portion of the at least one accommodation portion is provided with the manipulation assembly;
one accommodation portion is provided, and a projection of the accommodation portion in the first direction at least partially overlaps a projection of one wristband connection portion of the two wristband connection portions in the first direction; or
two accommodation portions are provided, the two accommodation portions are in one-to-one correspondence with the two wristband connection portions, and a projection of one accommodation portion of the two accommodation portions in the first direction at least partially overlaps a projection of a wristband connection portion corresponding to the one accommodation portion in the first direction.

11. A smart wearable device, comprising a control module and the smart wearable shell structure of claim 1, and the control module is disposed inside the smart wearable shell structure.

12. The smart wearable device of claim 11, wherein the manipulation assembly comprises a rotary shaft key and a bracket, the bracket is slidably mounted on the accommodation portion, the rotary shaft key is rotatably connected to the bracket, so that the manipulation assembly has a third state in which the manipulation assembly rotates relative to the housing, and at least part of the rotary shaft key is exposed from the accommodation portion.

13. The smart wearable device of claim 12, wherein the bracket is slidably mounted on the accommodation portion in a second direction, an axial direction of the rotary shaft key is a third direction, and every two of the second direction, the third direction and the first direction are perpendicular to each other.

14. The smart wearable device of claim 12, wherein the smart wearable shell structure further comprises a rotary sensing component, wherein the rotary sensing component is disposed on the accommodation portion and is electrically connected to a control module, and the rotary sensing component is configured to sense a rotation of the rotary shaft key, so that the control module performs a corresponding control according to the rotation of the rotary shaft key.

15. The smart wearable device of claim 14, wherein the rotary sensing component is a photoelectric sensor, and the rotary shaft key has a light-transmitting structure in a circumferential direction of the rotary shaft key to enable the rotary sensing component to sense the rotation of the rotary shaft key.

16. The smart wearable device of claim 15, wherein the rotary shaft key comprises a shaft key main body and a plurality of convex tooth portions, the plurality of convex tooth portions are disposed at intervals in a circumferential direction of the shaft key main body, and the light-transmitting structure is formed between adjacent convex tooth portions among the plurality of convex tooth portions.

17. The smart wearable device of claim 15, wherein the accommodation portion has a light-transmitting portion, and the rotary sensing component and the rotary shaft key are disposed on two sides of the light-transmitting portion.

18. The smart wearable device of claim 12, wherein the manipulation assembly further comprises an elastic member, the elastic member is disposed between a side wall of the accommodation portion and the bracket, and the elastic member is configured to drive the bracket to move in a direction facing away from the touch sensing member to enable the manipulation assembly to be automatically reset from the second state to the first state.

19. A control method based on a smart wearable device, wherein the smart wearable device comprises a control module and a smart wearable shell structure, and the control module is disposed inside the smart wearable shell structure; wherein the smart wearable shell structure comprises:
a housing, wherein an outer wall of the housing is provided with a wristband connection portion and an accommodation portion, a projection of the accommodation portion in a first direction at least partially overlaps a projection of the wristband connection portion in the first direction, and the first direction is a thickness direction of the housing;
a touch sensing member disposed within the housing; and
a manipulation assembly, slidably mounted on the accommodation portion, wherein at least part of the manipulation assembly is exposed from the housing, one end of the manipulation assembly extends into the housing, the manipulation assembly has a first state in which the manipulation assembly is kept stationary relative to the housing and a second state in which the manipulation assembly triggers the touch sensing member;
the control method comprises:
when the manipulation assembly is in the first state, feeding back a first signal to the control module;
when the manipulation assembly is in the second state, feeding back a second signal to the control module; and
when the manipulation assembly is in the third state, feeding back a third signal to the control module.

20. The control method of claim 19, wherein two manipulation assemblies are provided, wherein the two manipulation assemblies are capable of being operated in a combination of one of the first state, the second state and the third state of one control assembly, and one of the first state, the second state and the third state of another control assembly to feed back different signals to the control module.
